(19) United States
(12) Patent Application Publication
(10) Pub. No.: US 2017/0148103 A1
(43) Pub. Date: May 25, 2017

(54) METHOD FOR GENERATING A PRECEDENT RISK-MITIGATION SCHEDULE FOR A CUSTOMER SEGMENT

(71) Applicant: MasterCard International Incorporated, Purchase, NY (US)

(72) Inventors: Shweta KHATTAR, Dwarka (IN); Amit GUPTA, New Delhi (IN); Nidhi TANEJA, New Delhi (IN)

(21) Appl. No.: 15/346,398

(22) Filed: Nov. 8, 2016

(30) Foreign Application Priority Data
Nov. 19, 2015 (SG) 10201509533X

(51) Int. Cl. G06Q 40/08; G06Q 30/02

(52) U.S. Cl. CPC G06Q 40/08; G06Q 30/0204

(57) ABSTRACT

A method for generating a precedent risk-mitigation schedule for a customer segment is provided. The method includes obtaining financial data of a first plurality of at-risk entities defined by a plurality of parameters, and determining a customer segment including a second plurality of at-risk entities having at least one common parameter. The method further includes identifying one or more constraints for a respective one or more parameters defining each at-risk entity in the second plurality of at-risk entities, and using a schedule generator to generate an entity profile for each at-risk entity in the second plurality of at-risk entities, further generate a precedent entity profile based on the entity profile for each at-risk entity, and produce a precedent risk-mitigation schedule for the precedent entity profile. The method also includes identifying a further at-risk entity from the customer segment, and applying the precedent risk-mitigation schedule to the further at-risk entity.

### CROSS REFERENCE TO RELATED APPLICATIONS

This application claims the benefit of Singapore Patent Application No. 10201509533X filed Nov. 19, 2015, which is hereby incorporated by reference in its entirety.

### BACKGROUND

The present disclosure relates to risk-mitigation schedules, such as insurance policies. Such schedules endeavor to reduce the risk to which an at-risk entity, such as a business or person, is exposed. That risk may be physical or financial risk.

The present disclosure relates particularly to methods for generating a precedent risk-mitigation schedule for broad application across a customer segment.

Many at-risk entities, such as people or businesses, experience injury or loss as a result of contingencies. By their very nature, contingencies cannot be predicted. However, many organizations compensate at-risk entities upon occurrence of a contingency. Such organizations use a schedule (i.e. a risk-mitigation schedule) to define the types of contingencies for which an at-risk entity will receive compensation, and the amount of that compensation.

Since contingencies are unplanned or unpredictable events, it can be difficult for an at-risk entity to determine whether it has acquired an appropriate risk-mitigation schedule. Moreover, since the organization offering the risk-mitigation schedule is not comparable to the at-risk entity (i.e. the individual or business) seeking that schedule, it can be difficult for the organization to determine the types of contingencies to which the at-risk entity is exposed.

Moreover, at-risk entities may not be aware of the need for a risk-mitigation schedule or what that risk-mitigation schedule should contain.

It would, therefore, be desirable to provide a system and method for enabling the creation of a risk-mitigation schedule that is broadly relevant to a customer segment, to simplify selection of an appropriate risk-mitigation schedule.

### BRIEF DESCRIPTION

The present disclosure provides a method for generating a precedent risk-mitigation schedule for a customer segment, the method includes obtaining financial data of a first plurality of at-risk entities, each at-risk entity being defined by a plurality of parameters, determining, from the financial data, a customer segment including a second plurality of at-risk entities each having at least one common parameter, each at-risk entity in the second plurality of at-risk entities being also within the first plurality of at-risk entities, identifying, using a processor, one or more constraints for a respective one or more parameters defining each at-risk entity in the second plurality of at-risk entities, each constraint being either a range including the value of the respective parameter, or a Boolean variable representing the value of the respective parameter, and using a schedule generator to generate an entity profile for each at-risk entity in the second plurality of at-risk entities, using a plurality of the constraints including each constraint that defines a respective common parameter of the at least one common parameter, generate a precedent entity profile based on the entity profile for each at-risk entity, and produce a precedent risk-mitigation schedule for the precedent entity profile, identifying a further at-risk entity from the customer segment, and applying the precedent risk-mitigation schedule to the further at-risk entity.

The present disclosure also provides a computer system for generating a precedent risk-mitigation schedule for a customer segment, the method includes a memory device for storing data, a display, and a processor coupled to the memory device and being configured to obtain financial data of a first plurality of at-risk entities, each at-risk entity being defined by a plurality of parameters, determine, from the financial data, a customer segment including a second plurality of at-risk entities each having at least one common parameter, each at-risk entity in the second plurality of at-risk entities being also within the first plurality of at-risk entities, and identify, using a processor, one or more constraints for a respective one or more parameters defining each at-risk entity in the second plurality of at-risk entities, each constraint being either a range including the value of the respective parameter, or a Boolean variable representing the value of the respective parameter, and a schedule generator coupled to the processor and configured to generate an entity profile for each at-risk entity in the second plurality of at-risk entities, using a plurality of the constraints including each constraint that defines a respective common parameter of the at least one common parameter, generate a precedent entity profile based on the entity profile for each at-risk entity, and produce a precedent risk-mitigation schedule for the precedent entity profile, the processor being further configured to identify a further at-risk entity from the customer segment, and apply the precedent risk-mitigation schedule to the further at-risk entity.

The present disclosure further provides a computer program embodied on a non-transitory computer readable medium for generating a precedent risk-mitigation schedule for a customer segment, the program including at least one code segment executable by a computer to instruct the computer to obtain financial data of a first plurality of at-risk entities, each at-risk entity being defined by a plurality of parameters, determine, from the financial data, a customer segment including a second plurality of at-risk entities each having at least one common parameter, each at-risk entity in the second plurality of at-risk entities being also within the first plurality of at-risk entities, identify, using a processor, one or more constraints for a respective one or more parameters defining each at-risk entity in the second plurality of at-risk entities, each constraint being either a range including the value of the respective parameter, or a Boolean variable representing the value of the respective parameter, generate an entity profile for each at-risk entity in the second plurality of at-risk entities, using a plurality of the constraints including each constraint that defines a respective common parameter of the at least one common parameter, generate a precedent entity profile based on the entity profile for each at-risk entity, produce a precedent risk-mitigation schedule for the precedent entity profile, the processor being further configured to identify a further at-risk entity from the customer segment, and apply the precedent risk-mitigation schedule to the further at-risk entity.

Unless context dictates otherwise, the following terms will have the meaning given here.

The term “customer segmentation” is understood to mean the subdivision of a market into discrete customer groups, where the customers in a particular group share similar characteristics. Correspondingly, the term “customer segment” will be understood to refer to one of those discrete customer groups. Moreover, a customer segment may include a demographic, such as the relative affluence (e.g. the monthly income or spend), of at-risk entities.

The term “entity” includes an individual, business, collection of individuals or businesses or any other party that may experience a contingency. The entity may also be a virtual or hypothetical entity such that the methods described herein can be used for speculative purposes and modelling risk-mitigation schedules.

The term “contingency” refers to any unexpected event that may cause financial or physical loss to the entity experiencing the contingency. For example, where the entity is an individual, the contingency may be a physical disablement (partial or full), destruction, theft, or loss of property.

The term “at-risk”, as used in relation to an entity as described above, refers to any entity which may be subjected to a contingency or negatively-impacting event in which financial or physical loss is experienced.

The term “risk-mitigation schedule provider” may be any party, or their representative, that provides compensation to an at-risk entity in the event that the entity experiences a contingency.

The term “exception”, when used in relation to a risk-mitigation schedule, refers to an absence or difference between the risk-mitigation schedule of the entity in question and the precedent risk-mitigation schedule determined using the methods taught herein.

The term “risk-mitigation schedule” refers to a schedule, report or similar that defines the contingencies that are compensable and the conditions, if any, under which compensation will or will not be given. A risk-mitigation schedule may also set out other information, such as any limits applied to the compensation.

A “risk-mitigation provider” is any party that provides compensation in line with a risk-mitigation schedule, in the event of a contingency, or the agent of such a party.

### BRIEF DESCRIPTION OF THE DRAWINGS

Some embodiments of the methods taught herein will now be described, by way of non-limiting example only, with reference to the accompanying drawings in which:

FIG. 1 shows a method for generating a precedent risk-mitigation schedule for a customer segment.

FIG. 2 shows a schematic embodiment of a system for generating a precedent risk-mitigation schedule for a customer segment.

FIG. 3 shows an exemplary computing device suitable for executing the method for generating a precedent risk-mitigation schedule for a customer segment.

FIG. 4 is a schematic data flow diagram of a method in accordance with present teachings.

### DETAILED DESCRIPTION

Some portions of the description that follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic, or optical signals capable of being stored, transferred, combined, compared, and otherwise manipulated.

Unless specifically stated otherwise, and as apparent from the following, it will be appreciated that throughout the present specification, discussions utilizing terms, such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission, or display devices.

The present specification also discloses apparatus for performing the operations of the methods. Such apparatus may be specially constructed for the required purposes, or may include a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the methods described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices, such as magnetic or optical disks, memory chips, or other storage devices suitable for interfacing with a computer. The computer readable medium may also include a hard-wired medium, such as exemplified in the Internet system, or wireless medium, such as exemplified in the GSM mobile telephone system. The computer program when loaded and executed on such a computer effectively results in an apparatus that implements the steps of the exemplary method.

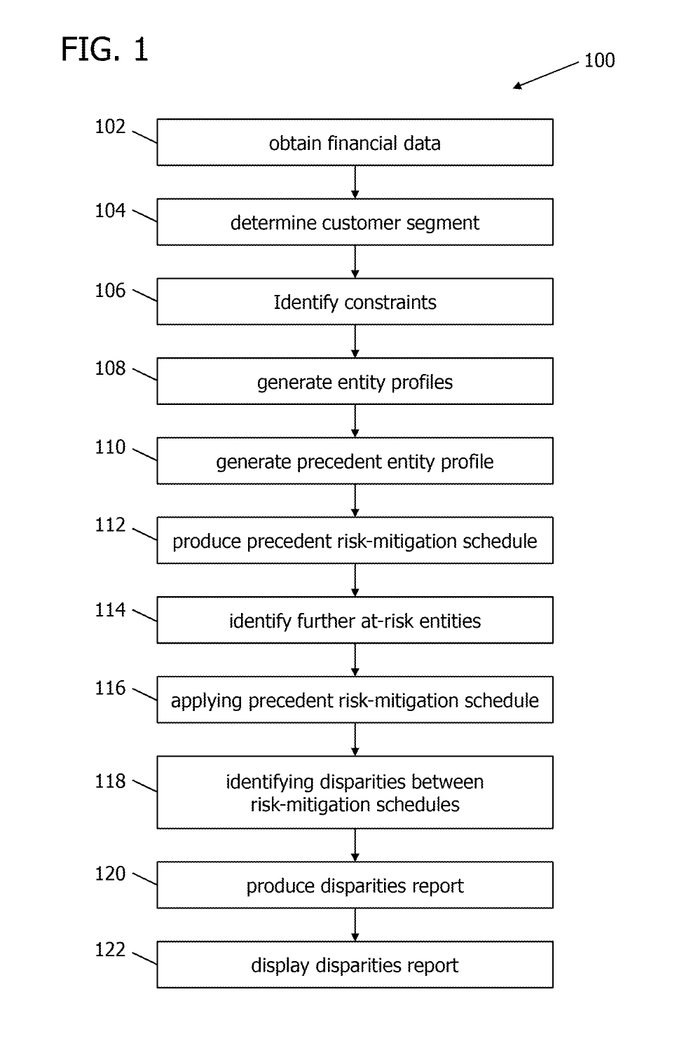

FIG. 1 illustrates a method 100 for generating a precedent risk-mitigation schedule for a customer segment. Broadly speaking, the method includes the steps of:
Step 102: obtaining financial data of at-risk entities;
Step 104: determining a customer segment;
Step 106: identifying constraints;
Step 108: generating entity profiles;
Step 110: generating a precedent entity profile;
Step 112: producing a preceding risk-mitigation schedule;
Step 114: identifying further customers (i.e. at-risk entities); and
Step 116: applying the preceding risk-mitigation schedule to the further customers.

At step 102, financial data is obtained. The financial data relates to a first plurality of at-risk entities, such as a group of individuals. That first plurality of at-risk entities forms a test group from which a customer segment can be identified, the customer segment including a second plurality of at-risk entities with some common attributes or characteristics (i.e. parameters).

The financial data can enable a number of deductions to be made about the spending habits and decisions made by at-risk entities. These deductions are made by identifying parameters, from the financial data, that describe the customer segment in inferring behavior about customers in that customer segment. For example, financial data of an at-risk entity showing regular spending relating to travel may indicate that the at-risk entity travels often, would be at risk of contingencies (e.g. baggage loss or missed connections) relating to travel and may desire compensation in the occurrence of such a contingency. Thus a risk-mitigation schedule generated for a customer segment including regular travelers may include travel insurance (e.g. insurance for baggage loss or damage, missed connections, and so forth).

Each at-risk entity is defined by a plurality of parameters by which the at-risk entities can be analyzed and the likelihood of contingencies occurring to those entities can be determined or inferred. Each of the parameters is indicative of a property or characteristic of the at-risk entity. At least one of the parameters can be derived from financial data and relates to all at-risk entities in a customer segment. Each parameter has a value and a value-type. The value-type infers a property or characteristic of the entities in a customer segment that may affect the likelihood of those entities experiencing a contingency (e.g. stroke, injury, loss, or theft), and the value is the value of that property of characteristic. Moreover, the value-type may depend on the nature of the entities in the customer segment. For example, where each such entity is an individual, a value-type may be the income of the individual, whether or not the individual is a smoker or the average monthly spend of the individual. With regard to the average monthly spend, the value-type may be even more granular, such as the average monthly spend on medical services, a particular type of medical service (e.g. dentistry, ophthalmology, physiotherapy, or chiropractic services), cigarettes, food, particular food types (e.g. categories of food, such as fat foods, vegetables, or meats), alcohol, travel, and so forth, and the value in each case would be a currency (e.g. $). Similarly, where the value-type is an individual's age, the value would be, for example, 34 years.

Where each at-risk entity is a business, the value-types may be monthly revenue, type of industry (e.g. mining, medical, or food & beverage), number of employees and so forth, and, in each of these example cases, the value would be numerical. Thus, the parameters may differ depending on the nature of the entities in the customer segment.

Lifestyle and discretionary decisions can influence the behavior of entities, and their appetite for risk, particularly where entities are individuals. Lifestyle and discretionary decisions are, therefore, key contributors to the likelihood that the entities in a customer segment will experience a contingency and, thus, increase the likelihood that compensation for such a contingency will need to be paid. By deriving the value-type and value of at least one parameter from financial transaction data of at-risk entities, it becomes possible to have lifestyle and discretionary financial decisions of at-risk entities influence the risk-mitigation schedules generated for those entities (e.g. transactions relating to skydiving, mountain bike riding, and other spending that would indicate the at-risk entity intentionally places itself in a position of potential physical harm). Such financial transaction data may include one or more of the monthly spend items stated above, or any other piece of financial data.

Data from which parameters are determined can be inputted by a user (e.g. into an app interface, a web portal, or other interface). Such data may also be received from other sources. For example, data may be received from an issuer bank (e.g. Citibank®), such as the issuer of a type of credit card belonging to a number of at-risk entities, an insurer that may or may not already hold an insurance policy for some of the at-risk entities, or a research business.

Where data is received from an issuer bank, it will be called “issuer-held” data. Issuer-held data is taken to include any data held by the issuer bank, such as the age, gender, income, and residential address of at-risk entities. Issuer-held data can enable the creation (e.g. determination) of parameters based on the types of products or services procured by a group of at-risk entities. Customer segments can then be formulated using these parameters.

Data received from an insurer will be called “insurer data”. Insurer data can also include a significant amount of information about the at-risk entity, such as their age, smoker status (though this can also often be derived from issuer-held data by identifying purchases of cigarettes), residential address, and any previous or existing risk-mitigation schedules (e.g. insurance policies). Thus, the insurer data can include an existing risk-mitigation schedule of an at-risk entity in the customer segment, or one or more parameters of such an at-risk entity.

At-risk entities are defined by parameters (e.g. age, gender, income band, residential address), by which the at-risk entities can be grouped into customer segments. Thus, a customer segment can be determined by identifying a group of at-risk entities that have at least one parameter in common (step 104). The customer segment, therefore, includes customers having that common parameter, whether or not the customers having that parameter were part of the initial group from which the customer segment was determined.

The common parameter or parameters may be drawn from the financial data mentioned above. Financial data indicates spending behavior, such as the average spend per account or month, the industry in which the spend occurs (e.g. retail), the nature of the spend (e.g. discretionary or essential), or the mode of spending (e.g. online purchase, in-store purchase, payment by cash or payment with credit), and can, thus, readily be used to create distinct customer segments. By identifying at least one parameter common to a number of the at-risk entities to whom the financial data relates, a plurality of at-risk entities can be identified that fall within the customer segment and can be distinguished from other at-risk entities to whom that financial data relates, but whom do not fall within the customer segment.

Once an at-risk entity is associated with a customer segment, certain additional characteristics of the at-risk entity can be inferred on the basis that such characteristics are, at least in general, common to other entities in the same customer segment. To illustrate, where an individual is a 40 year old male living in an affluent suburb, one or more parameters may be able to be determined on the basis that those one or more parameters apply, in general, to 40 year old males living in affluent suburbs.

Thus, at-risk entities that have not been used in the creation of the risk-mitigation schedule, in accordance with the methods described herein, may yet form part of the customer segment on the basis that they share the common attributes or parameters that define the customer segment (e.g. age or gender). As a result, financial data pertaining to a limited set of at-risk entities, namely a first plurality or group of at-risk entities, can be analyzed to identify a subset of at-risk entities, namely a second plurality or group of at-risk entities, that share at least one common parameter that is evident from the financial data. Once an at-risk entity has been found to have the one or more common parameters from which the customer segment was formed, the remaining parameters for that customer segment can be assumed to apply to the at-risk entity. Moreover, additional inferences can be drawn about the at-risk entity on the basis of data relating to the customer segment, such as data received or obtained from a research business. That customer segment data may relate to products and services commonly acquired by the customer segment, or any other relevant information, from which one or more further parameters of the at-risk entity can be determined.

At step 106, a constraint is identified for each parameter defining each at-risk entity from the plurality of at-risk entities used to define the customer segment (i.e. the second plurality of at-risk entities). Each constraint is either a range including the value of the respective parameter, or a Boolean variable representing the value of the respective parameter. To illustrate, where the at-risk entities are individuals and the value-type of a parameter is the monthly income of each individual, the value may be, for example, $5,000 per month. The corresponding constraint may then be a range of monthly income, including the value in question (e.g. $5,000 to $5,999). A Boolean variable, instead, defines something that is either correct or incorrect. For example, where each at-risk entity is an individual and the value-type is the respective individual's smoker status, the value is True or False—in other words, each individual is either a smoker or they are not a smoker.

Some parameters may be related. For example, a Boolean variable representing smoker status may be related to a range constraint indicating an individual's average monthly spend on cigarettes.

Each parameter may be weighted. The weighting may be applied according to the value-type and whether the value-type represents a property or characteristic that is more or less likely to influence the occurrence of a contingency. For example, where each at-risk entity is an individual, the respective individual's monthly spend at fast food restaurants may be deemed indicative of that individual's health and, thus, effect the likelihood (e.g. a statistical likelihood) the individual will experience health problems. Thus, emphasis can be given to those parameters that result in a greater likelihood of a contingency arising than other parameters. Similarly, those parameters that are less likely to contribute to the occurrence of contingencies can be given a lower weighting and are, thus, de-emphasized.

Step 108 involves the generation of an entity profile, using the constraints, for each at-risk entity that was used to define the customer segment. An entity profile is, in effect, a data structure or record of the constraints. Each entity profile may be specific to a respective entity at a particular point in time, and be compared to an entity profile generated for the same respective entity at a later point in time, thus, enabling analysis of the change in risk-mitigation schedules over time. For example, where each at-risk entity is again an individual, older individuals are more likely to experience hospitalization than younger individuals. Therefore, the likelihood of a hospitalization type of contingency occurring generally increases with age. Similarly, an individual between 18 and 25 years of age is statistically more likely to have a car accident (i.e. an injurious contingency, or damage to property) than an individual of the age of 40—such statistics can be derived from customer segment data provided by a research business as mentioned above.

Since one or more parameters were determined as being common to each of a plurality of at-risk entities, thereby enabling a customer segment to be identified containing those entities, the entity profiles should include the constraint or constraints that relate to the common parameter or parameters from which the customer segment was identified. This will ensure the subsequently generated precedent risk-mitigation schedule includes the properties or characteristics of the at-risk entities that are relevant to the customer segment and, thus, relevant to other customers in that customer segment.

Step 110 relates to the mapping of a precedent entity profile to one or more other entity profiles that have been previously prepared for particular entities. In particular, a precedent entity profile is generated based on the entity profiles for each at-risk entity from which the customer segment was defined. There are a number of ways to generate a precedent entity profile including applying a least squares regression algorithm to the constraints in each at-risk entity profile. A least squares regression algorithm can be applied by determining a data point—the data point will, in practice, correspond to a value or range of a constraint—that minimizes the squares of the deviations between that data point and the corresponding constraint from each entity profile—a “corresponding constraint” will, in general, be the same type of constraint, such as income, age, or gender. Where a constraint is Boolean, it is either a ‘yes’ or a ‘no’, so a precedent entity profile cannot contain a constraint that is somewhere in the middle. For example, where the constraint is the smoker status of an at-risk entity, the precedent profile should relate to a customer segment in which the at-risk entities are smokers, or (i.e. ‘exclusively or’) they are not smokers. For Boolean constraints the least squares algorithm may lean closer to one status than the other, and that status will be used in the precedent entity profile. Alternatively, where there is no clear delineation between statuses (e.g. where 48% of the at-risk entities in the customer segment are smokers and 52% are not smokers) then the precedent entity profile may omit that constraint. Notably, the common constraints will be in each entity profile and will, thus, be in the precedent entity profile. The above calculations, therefore, determine other constraints that may be useful in determining whether another at-risk entity adheres more, or less, closely to all of the constraints defining the customer segment.

The precedent entity profile may instead take an average of the constraints in each at-risk entity profile or use any other desired method for defining a precedent entity profile that can suitably be applied to at-risk entities in a customer segment.

Rather than, or in addition to, omitting constraints from the precedent entity profile, the constraints in the precedent entity profile may also be weighted so that particular properties or characteristics of the ‘ideal’ at-risk entity—in other words, the at-risk entity that best conforms to the precedent entity profile for the customer segment—are emphasized when compared with other properties or characteristics. For example, if the smoker status in the precedent entity profile is emphasized, only those at-risk entities with that same status may be considered (per step 114) to form part of the customer segment. In this sense, a single constraint, such as the smoker-status, can have a significant influence on the decision of whether or not a particular at-risk entity forms part of the customer segment and can, thus, have the precedent risk-mitigation schedule applied to them at step 116. Conversely, where one constraint for the precedent entity profile is not as relevant to the risk of an individual entity experiencing a contingency, such as monthly income or spend on entertainment, that constraint may be given a very low weighting since it is unlikely to effect the probability that the at-risk entity will experience a contingency.

Once the precedent entity profile has been identified, it can be used to produce a precedent risk-mitigation schedule per step 112. The precedent risk-mitigation schedule may be generated by a risk-mitigation schedule provider based on the constraints defined in the precedent entity profile. Alternatively, where one of more of the entities by which the customer segment was defined have already established risk-mitigation schedules, the precedent risk-mitigation schedule may be the average of the risk-mitigation schedules of those entities. Where multiple risk-mitigation schedules of at-risk entities are used to form the precedent risk-mitigation schedule, the average may be taken, and that average may be weighted according to the similarity of each individual at-risk entity, and their corresponding profile, to the precedent entity profile. For example, the risk-mitigation schedule relating to a precedent profile that is closer to the precedent entity profile may be given a higher weighting than the risk-mitigation schedule of a precedent profile that is further from the precedent entity profile. Alternatively, one or more of the constraints may be weighted and the greater the deviation in that constraint, the lower the weighting. In other words, the weighting is inversely applied relative to the deviation in a constraint. To illustrate, if a constraint in the precedent entity profile is an age range of age 30 to 34, meaning the ‘ideal’ at-risk entity is between 30 and 34 years of age, then a first entity profile of an at-risk entity in the same customer segment, and having an age range of 60 to 64, will receive a lower weighting than a second precedent profile in that customer segment and with an age range of 40 to 44.

The creation of a precedent risk-mitigation schedule enables an at-risk entity in the customer segment to quickly determine if their risk-mitigation schedule fulfils the norms for risk-mitigation schedules of similar entities. In addition, risk-mitigation schedule providers can then identify—using financial data or any other data from which at-risk entities in the customer segment can be identified—further at-risk entities per step 114 that fall within the customer segment. In this context, a risk-mitigation schedule may be an insurance schedule, insurance policy, or similar.

Although the customer segment was determined based on data covering a limited number of at-risk entities, it can be extended to cover similar at-risk entities each having the common parameter or parameters by which the customer segment was defined, even where those further at-risk entities are outside of the limited number of at-risk entities when the customer segment was created. In other words, once the precedent risk-mitigation schedule has been developed it can be applied across the customer segment, to all at-risk entities in that customer segment, whether or not those at-risk entities were known when the customer segment was developed (per step 116).

The precedent risk-mitigation schedule may also be adjusted prior to being applied to further at-risk entities. Where, for example, the precedent risk-mitigation schedule is supplied by, or in accordance with the requirements of, a risk-mitigation schedule provider, such a provider may desire to change the types of contingencies for which compensation will be given, or the amount of any such compensation. Such a provider may be an insurance company or insurer. The risk-mitigation schedule may also be provided by an insurance broker or other agent that acts as a proxy or representative of an insurer.

Where an at-risk entity already holds a risk-mitigation schedule, applying the precedent risk-mitigation schedule to that entity may involve comparing it against the risk-mitigation schedule of the at-risk entity to determine whether there is a disparity or multiple disparities (per step 118 which is indicated as optional using a broken line). In other words, the risk-mitigation schedule of the at-risk entity is compared against the precedent risk-mitigation schedule to determine if there are any differences between any of the constraints. These disparities or differences suggest whether or not the at-risk entity has, or has sufficient, compensation specified for particular types of contingency.

Once the disparities have been identified, they are consolidated into an exceptions report or exceptions schedule (per optional step 120). The exceptions report or exceptions schedule includes the disparity or disparities identified under step 118. The exceptions schedule sets out the particular contingencies for which the current risk-mitigation schedule of the further at-risk entity has no, or insufficient, compensation. The exceptions schedule may also set out where the further at-risk entity may have planned on too much compensation. For example, where the risk-mitigation schedule is an insurance policy, the exceptions schedule may set out where the at-risk entity has no insurance but should, where the at-risk entity is underinsured, or where the at-risk entity is over-insured.

The exceptions report or exceptions schedule may list the disparities or may present them in any other desired manner. The further at-risk entity is then presented in the exceptions schedule on a display per optional step 122. Thus, the further at-risk entity can determine whether there are sufficient differences (i.e. disparities), and the nature of those differences, to warrant an adjustment of their existing risk-mitigation schedule, or establishment of a new schedule where the further at-risk entity has none in place prior to performance of the present method. Where the further at-risk entity has not previously arranged for compensation in the event of contingencies (i.e. has no risk-mitigation schedule, which is equated to an empty (or null) schedule), the exceptions schedule will be substantially the same as the precedent risk-mitigation schedule.

It may also be desirable to apply one or more adjustments to the exceptions schedule, the one or more adjustments being to perform at least one of adding a disparity to the exceptions schedule removing a disparity from the exceptions schedule and adjusting a disparity in the exceptions schedule. Adjustments may be made for any reason, including offering promotions or upgrades to insurance, applying discounts, adjusting for singular circumstances, and so forth. Singular circumstances may include, for example, where the precedent risk-mitigation schedule is being marketed to individuals in the customer segment and who live in a flood prone area. In such a case, a risk-mitigation schedule provider may be unwilling to offer flood coverage, whether or not the risk-mitigation profiles of the at-risk entities forming the customer segment generally included such coverage.

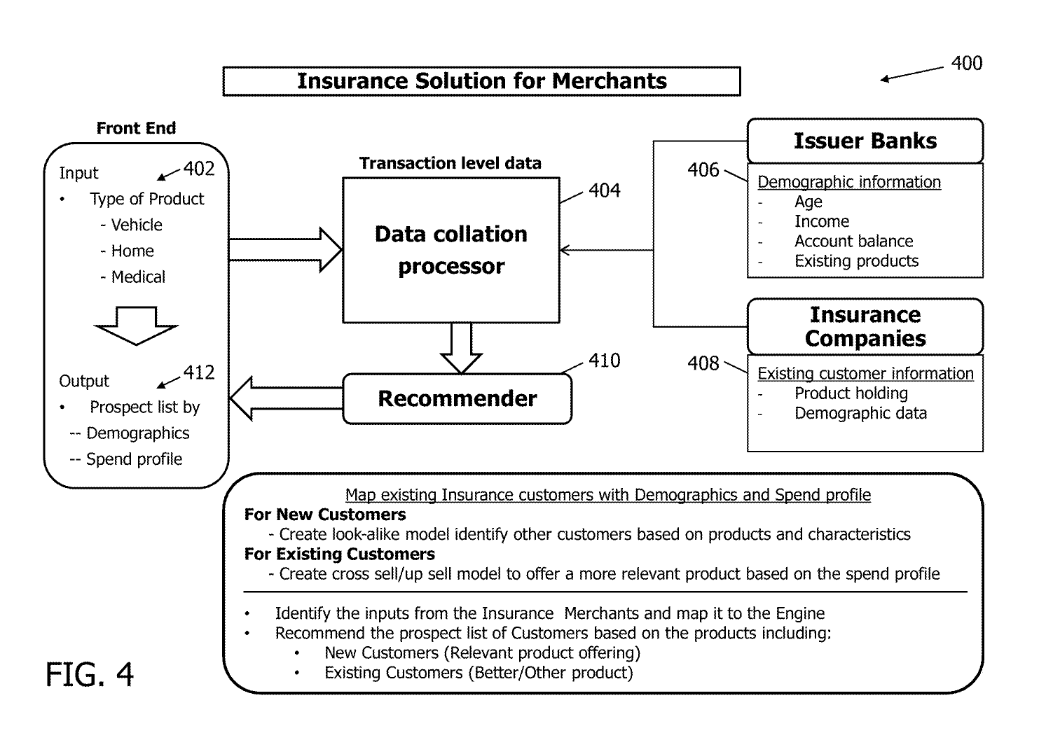

With reference to FIG. 4, a schematic representation of the method is shown, in terms of inputs, outputs, and interactions. From a user perspective, a product request (e.g. for a precedent risk-mitigation schedule including a vehicle, home, or medical insurance schedule) is made through the input module 402. The request includes an input or receipt of financial data relating to a group of at-risk entities. That request is sent to a data collation processor 404 that collects data from issuer banks 406, such as data relating to demographics and products, and insurance companies 408, such as insurance product information or previous risk-mitigation schedules of the at-risk entity. The processor 404 identifies any further parameters, associates the parameters with constraints, and sends those constraints to the schedule generator or recommender engine 410. The recommender engine 410 processes the constraints and produces a precedent risk-mitigation schedule. The precedent risk-mitigation schedule is sent to the output module 412, which may be the same as the input module 402.

When the precedent risk-mitigation schedule is applied to an at-risk entity who is in the customer segment and already holds a risk-mitigation schedule, application of the precedent risk-mitigation schedule may include a cross-sell, wherein a discount is offered for establishing a risk-mitigation schedule for a different product (e.g. home insurance versus health insurance), or an upsell, where a product is offered based on, for example, an increased likelihood of contingencies occurring in future (e.g. as people age, they may wish to add chiropractic compensation to their risk-mitigation schedule, or pregnancy compensation in the event of unexpected problems during pregnancy).

When the precedent risk-mitigation schedule is applied to an at-risk entity that is in the customer segment and holds no risk-mitigation schedule, then the precedent risk-mitigation schedule can be applied in full, as the recommended risk-mitigation schedule for that at-risk entity.

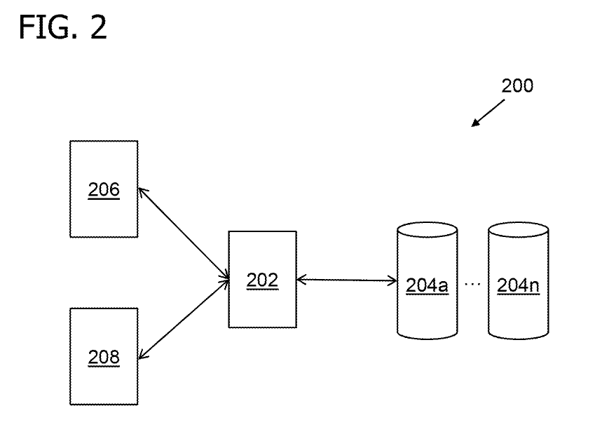

FIG. 2 shows an illustrative schematic of a network-based system 200 for generating a precedent risk-mitigation schedule for a customer segment. The system 200 includes a computer 202, one or more databases 204a . . . 204n, a user input module 206 and a user output module 208. Each of the one or more databases 204a . . . 204n is communicatively coupled with the computer 202. The user input module 206 and a user output module 208 may be separate and distinct modules communicatively coupled with the computer 202. For example, a user may be a risk-mitigation schedule provider or their agent. Whoever requests the precedent risk-mitigation schedule to be prepared will do so through the user input module 206. Where the risk-mitigation schedule provider requests the risk-mitigation schedule in relation to a particular customer segment, one or more at-risk entities from that customer segment may receive the exceptions schedule through the user output module 208. Thus, the user input module 206 and user output module 208 are different. In a similar process, a bank or other organization may be supplied the precedent risk-mitigation schedule for onward supply to their customer who fit into the customer segment. The precedent risk-mitigation schedule may instead be co-branded on products supplied by the bank or other organization for customers that fall within the same customer segment, or details of the customers of the bank or other organization may be searched to identify customers falling within the customer segment who are then separately approached by the risk-mitigation schedule provider or their agent.

Alternatively, the user input module 206 and a user output module 208 may be integrated within a single device. For example, where the risk-mitigation schedule provider is producing and reviewing precedent risk-mitigation schedules, the user input module 206 may be the same as the user output module 208. That device may be a mobile electronic device (e.g. a mobile phone, a tablet computer, etc.). The mobile electronic device may have appropriate communication modules for wireless communication with the computer 202 via existing communication protocols.

The computer 202 may include at least one processor, a schedule generator, and at least one memory including computer program code, the at least one memory and the computer program code configured to, with at least one processor, cause the computer at least to (A) obtain financial data of a first plurality of at-risk entities, each at-risk entity being defined by a plurality of parameters, (B) determine, from the financial data, a customer segment including a second plurality of at-risk entities each having at least one common parameter, each at-risk entity in the second plurality of at-risk entities being also within the first plurality of at-risk entities, (C) identify, using a processor, a constraint for each parameter defining each at-risk entity in the second plurality of at-risk entities, each constraint being either a range including the value of the respective parameter, or a Boolean variable representing the value of the respective parameter, use the schedule generator to (D(i)) generate an entity profile for each at-risk entity in the second plurality of at-risk entities, using a plurality of the constraints including each constraint that defines a respective common parameter of the at least one common parameter, (D(ii)) generate a precedent entity profile based on the entity profile for each at-risk entity, and (D(iii)) produce a precedent risk-mitigation schedule for the precedent entity profile, (E) identify a further at-risk entity from the customer segment, and (F) apply the precedent risk-mitigation schedule to the further at-risk entity.

In an implementation, the computer 202 may be further caused to obtain financial data by (A(i)) receiving payment scheme data from a payment scheme (e.g. a credit card scheme) and/or (A(ii)) receiving issuer-held data from an issuer bank from which at least one of the plurality of parameters can be determined—this may include receiving issuer-held data regarding a demographic conforming to the customer segment, or receiving data regarding products or services procured by at-risk entities in the customer segment—and/or (A(iii)) receiving insurer data from an insurer from which at least one of the plurality of parameters can be determined—this may include receiving one or both of one or more risk-mitigation schedules of at-risk entities in the customer segment and at least one parameter relating to those at-risk entities—apply the preceding risk-mitigation schedule to the further entity by (F(i)) determining at least one disparity between the precedent risk-mitigation schedule and a risk-mitigation schedule of the further at-risk entity, which may include identifying at least one difference between a constraint of the precedent risk-mitigation schedule and a corresponding constraint of the risk-mitigation schedule of the further at-risk entity, (G) displaying, on a display, an exceptions schedule to the further at-risk entity, the exceptions schedule including the at least one disparity.

The various types of data, e.g. payment scheme data, such as electronic payment transaction data which may be created using a payment vehicle, such as a credit card, issuer-data obtained from the issuer bank, the insurer data obtained from an insurer, and the customer segment data obtained from a research business, can be stored on a single database (e.g. 204a), or stored in multiple databases (e.g. issuer-held data is stored on database 204a, insurer data is stored on database 204b, etc.). The databases 204a . . . 204n may be realized using cloud computing storage modules and/or dedicated servers communicatively coupled with the computer 202.

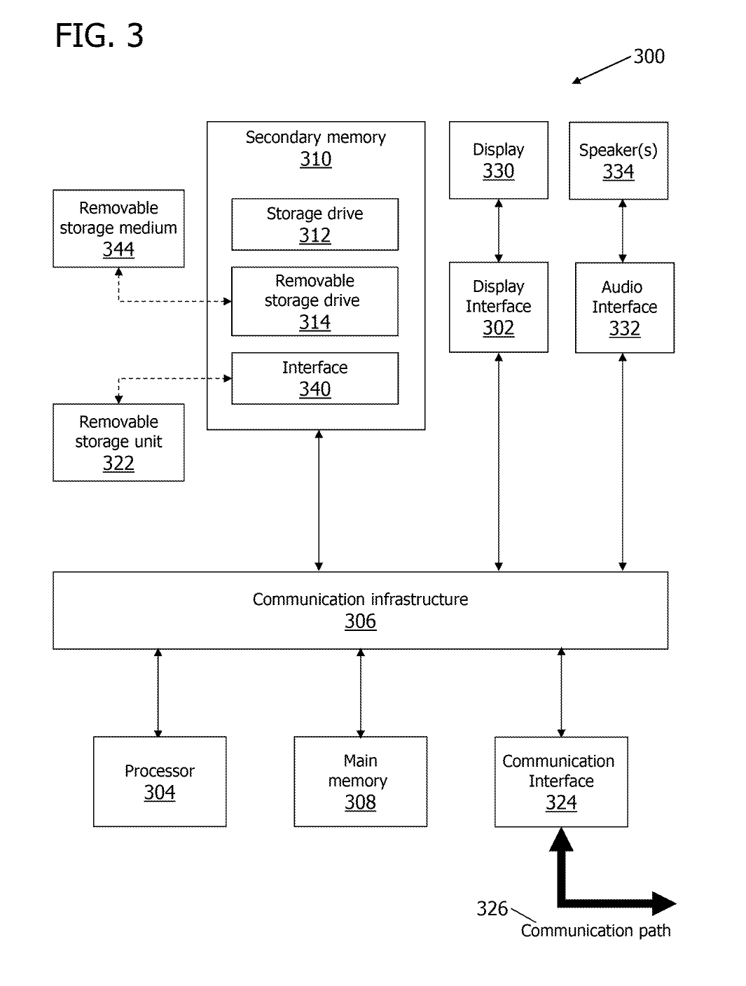

FIG. 3 depicts an exemplary computer/computing device 300, hereinafter interchangeably referred to as a computer system 300, where one or more such computing devices 300 may be used to facilitate execution of the above-described method for generating a precedent risk-mitigation schedule for a customer segment. In addition, one or more components of the computer system 300 may be used to realize the computer 202. The following description of the computing device 300 is provided by way of example only and is not intended to be limiting.

As shown in FIG. 3, the example computing device 300 includes a processor 304 for executing software routines. Although a single processor is shown for the sake of clarity, the computing device 300 may also include a multi-processor system. The processor 304 is connected to a communication infrastructure 306 for communication with other components of the computing device 300. The communication infrastructure 306 may include, for example, a communications bus, cross-bar, or network.

The computing device 300 further includes a main memory 308, such as a random access memory (RAM), and a secondary memory 310. The secondary memory 310 may include, for example, a storage drive 312, which may be a hard disk drive, a solid state drive, or a hybrid drive and/or a removable storage drive 314, which may include a magnetic tape drive, an optical disk drive, a solid state storage drive (such as a USB flash drive, a flash memory device, a solid state drive, or a memory card), or the like. The removable storage drive 314 reads from and/or writes to a removable storage medium 344 in a well-known manner. The removable storage medium 344 may include magnetic tape, optical disk, non-volatile memory storage medium, or the like, which is read by and written to by removable storage drive 314. As will be appreciated by persons skilled in the relevant art(s), the removable storage medium 344 includes a computer readable storage medium having stored therein computer executable program code instructions and/or data.

In an alternative implementation, the secondary memory 310 may additionally or alternatively include other similar means for allowing computer programs or other instructions to be loaded into the computing device 300. Such means can include, for example, a removable storage unit 322 and an interface 340. Examples of a removable storage unit 322 and interface 340 include a program cartridge and cartridge interface (such as that found in video game console devices), a removable memory chip (such as an EPROM or PROM) and associated socket, a removable solid state storage drive (such as a USB flash drive, a flash memory device, a solid state drive, or a memory card), and other removable storage units 322 and interfaces 340 which allow software and data to be transferred from the removable storage unit 322 to the computer system 300.

The computing device 300 also includes at least one communication interface 324. The communication interface 324 allows software and data to be transferred between computing device 300 and external devices via a communication path 326. In various embodiments of the disclosure, the communication interface 324 permits data to be transferred between the computing device 300 and a data communication network, such as a public data or private data communication network. The communication interface 324 may be used to exchange data between different computing devices 300 which such computing devices 300 form of part an interconnected computer network. Examples of a communication interface 324 can include a modem, a network interface (such as an Ethernet card), a communication port (such as a serial, parallel, printer, GPIB, IEEE 1393, RJ35, and USB), an antenna with associated circuitry, and the like. The communication interface 324 may be wired or may be wireless. Software and data transferred via the communication interface 324 are in the form of signals which can be electronic, electromagnetic, optical, or other signals capable of being received by communication interface 324. These signals are provided to the communication interface via the communication path 326.

As shown in FIG. 3, the computing device 300 further includes a display interface 302 which performs operations for rendering images to an associated display 330 and an audio interface 332 for performing operations for playing audio content via associated speaker(s) 334.

As used herein, the term “computer program product” may refer, in part, to removable storage medium 344, removable storage unit 322, a hard disk installed in storage drive 312, or a carrier wave carrying software over communication path 326 (wireless link or cable) to communication interface 324. Computer readable storage media refers to any non-transitory, non-volatile tangible storage medium that provides recorded instructions and/or data to the computing device 300 for execution and/or processing. Examples of such storage media include magnetic tape, CD-ROM, DVD, Blu-Ray™ Disc, a hard disk drive, a ROM or integrated circuit, a solid state storage drive (such as a USB flash drive, a flash memory device, a solid state drive, or a memory card), a hybrid drive, a magneto-optical disk, or a computer readable card, such as a SD card and the like, whether or not such devices are internal or external of the computing device 300. Examples of transitory or non-tangible computer readable transmission media that may also participate in the provision of software, application programs, instructions, and/or data to the computing device 300 include radio or infra-red transmission channels as well as a network connection to another computer or networked device, and the Internet or Intranets including e-mail transmissions and information recorded on Websites and the like.

The computer programs (also called computer program code) are stored in main memory 308 and/or secondary memory 310. Computer programs can also be received via the communication interface 324. Such computer programs, when executed, enable the computing device 300 to perform one or more features of embodiments discussed herein. In various embodiments, the computer programs, when executed, enable the processor 304 to perform features of the above-described embodiments. Accordingly, such computer programs represent controllers of the computer system 300.

Software may be stored in a computer program product and loaded into the computing device 300 using the removable storage drive 314, the storage drive 312, or the interface 340. Alternatively, the computer program product may be downloaded to the computer system 300 over the communications path 326. The software, when executed by the processor 304, causes the computing device 300 to perform functions of embodiments described herein.

It is to be understood that the embodiment of FIG. 3 is presented merely by way of example. Therefore, in some embodiments, one or more features of the computing device 300 may be omitted. Also, in some embodiments, one or more features of the computing device 300 may be combined together. Additionally, in some embodiments, one or more features of the computing device 300 may be split into one or more component parts.

1. A method for generating a precedent risk-mitigation schedule for a customer segment, the method comprising:
obtaining financial data of a first plurality of at-risk entities, each at-risk entity being defined by a plurality of parameters;
determining, from the financial data, a customer segment comprising a second plurality of at-risk entities each having at least one common parameter, each at-risk entity in the second plurality of at-risk entities being also within the first plurality of at-risk entities;
identifying, using a processor, one or more constraints for a respective one or more parameters defining each at-risk entity in the second plurality of at-risk entities, each constraint being either a range including the value of the respective parameter, or a Boolean variable representing the value of the respective parameter;
using a schedule generator to:
generate an entity profile for each at-risk entity in the second plurality of at-risk entities, using a plurality of the constraints including each constraint that defines a respective common parameter of the at least one common parameter;
generate a precedent entity profile based on the entity profile for each at-risk entity; and
produce a precedent risk-mitigation schedule for the precedent entity profile;
identifying a further at-risk entity from the customer segment; and
applying the precedent risk-mitigation schedule to the further at-risk entity.

2. The method according to claim 1, wherein identifying a further at-risk entity from the customer segment comprises identifying a further at-risk entity having each common parameter, the further at-risk entity being outside the first plurality of at-risk entities.

3. The method according to claim 1, wherein determining a customer segment comprises determining a demographic comprising each at-risk entity in the second plurality of at-risk entities.

4. The method according to claim 1, wherein obtaining financial data comprises receiving issuer-held data from an issuer bank.

5. The method according to claim 4, wherein receiving issuer-held data comprises receiving data regarding products or services procured by the first plurality of at-risk entities.

6. The method according to claim 1, wherein obtaining financial data comprises receiving payment scheme data from a payment scheme.

7. The method according to claim 6, wherein receiving financial data comprises receiving data regarding products or services procured by the first plurality of at-risk entities.

8. The method according to claim 1, further comprising receiving insurer data from an insurer from which at least one of the plurality of parameters can be determined.

9. The method according to claim 1, wherein using a schedule generator to produce a precedent risk-mitigation schedule comprises receiving insurer data from an insurer, the insurer data comprising a risk-mitigation schedule for at least one of the at-risk entities in the second plurality of at-risk entities, and producing the precedent risk-mitigation schedule based on the risk-mitigation schedule for the at least one of the at-risk entities in the second plurality of at-risk entities.

10. The method according to claim 9, wherein producing the precedent risk-mitigation schedule based on the risk-mitigation schedule for the at least one of the at-risk entities in the second plurality of at-risk entities, comprises using the risk-mitigation schedule as the precedent risk-mitigation schedule where the insurer data comprises only a single risk-mitigation schedule, and producing a precedent risk-mitigation schedule based on an average of all risk-mitigation schedules where the insurer data comprises more than one risk-mitigation schedule.

11. The method according to claim 1, further comprising receiving, from a research business, customer segment data relevant to the customer segment and relating to products and services commonly acquired by the customer segment, and determining from the customer segment data at least one additional parameter common to each at-risk entity in the customer segment.

12. The method according to claim 1, wherein generating a precedent entity profile based on the entity profile for each at-risk entity comprises applying a least squares regression algorithm to the constraints in each at-risk entity profile.

13. The method according to claim 1, wherein generating a precedent entity profile based on the entity profile for each at-risk entity comprises taking an average of the constraints in each at-risk entity profile.

14. The method according to claim 1, wherein applying the preceding risk-mitigation schedule to the further entity comprises determining at least one disparity between the precedent risk-mitigation schedule and a risk-mitigation schedule of the further at-risk entity.

15. The method according to claim 14, further comprising displaying, on a display, an exceptions schedule to the further at-risk entity, the exceptions schedule comprising the at least one disparity.

16. The method according to claim 14, wherein determining at least one disparity between the precedent risk-mitigation schedule and the risk-mitigation schedule of the further at-risk entity comprises identifying at least one difference between a constraint of the precedent risk-mitigation schedule and a corresponding constraint of the risk-mitigation schedule of the further at-risk entity.

17. The method according to claim 15, further comprising applying one or more adjustments to the exceptions schedule, the one or more adjustments being to perform at least one of:
adding a disparity to the exceptions schedule;
removing a disparity from the exceptions schedule; and
adjusting a disparity in the exceptions schedule.

18. A computer system for generating a precedent risk-mitigation schedule for a customer segment, the system comprising:
a memory device for storing data;
a display; and
a processor coupled to the memory device and being configured to:
obtain financial data of a first plurality of at-risk entities, each at-risk entity being defined by a plurality of parameters;
determine, from the financial data, a customer segment comprising a second plurality of at-risk entities each having at least one common parameter, each at-risk entity in the second plurality of at-risk entities being also within the first plurality of at-risk entities; and
identify, using a processor, one or more constraints for a respective one or more parameters defining each at-risk entity in the second plurality of at-risk entities, each constraint being either a range including the value of the respective parameter, or a Boolean variable representing the value of the respective parameter; and
a schedule generator coupled to the processor and configured to:
generate an entity profile for each at-risk entity in the second plurality of at-risk entities, using a plurality of the constraints including each constraint that defines a respective common parameter of the at least one common parameter;
generate a precedent entity profile based on the entity profile for each at-risk entity; and
produce a precedent risk-mitigation schedule for the precedent entity profile;
the processor being further configured to:
identify a further at-risk entity from the customer segment; and
apply the precedent risk-mitigation schedule to the further at-risk entity.

19. The system of claim 18, wherein the processor is configured to identify a further at-risk entity from the customer segment comprises by identifying a further at-risk entity having each common parameter, the further at-risk entity being outside the first plurality of at-risk entities.

20. The system of claim 18, wherein the processor is configured to determine a customer segment by determining a demographic comprising each at-risk entity in the second plurality of at-risk entities.

21. The system of claim 18, wherein the processor is configured to obtain financial data by receiving payment scheme data from a payment scheme.

22. The system of claim 21, wherein the processor is configured to receive financial data by receiving data regarding products or services procured by the first plurality of at-risk entities.

23. A computer program embodied on a non-transitory computer readable medium for generating a precedent risk-mitigation schedule for a customer segment, the program comprising at least one code segment executable by a computer to instruct the computer to:
obtain financial data of a first plurality of at-risk entities, each at-risk entity being defined by a plurality of parameters;
determine, from the financial data, a customer segment comprising a second plurality of at-risk entities each having at least one common parameter, each at-risk entity in the second plurality of at-risk entities being also within the first plurality of at-risk entities;
identify, using a processor, one or more constraints for a respective one or more parameters defining each at-risk entity in the second plurality of at-risk entities, each constraint being either a range including the value of the respective parameter, or a Boolean variable representing the value of the respective parameter;
generate an entity profile for each at-risk entity in the second plurality of at-risk entities, using a plurality of the constraints including each constraint that defines a respective common parameter of the at least one common parameter;
generate a precedent entity profile based on the entity profile for each at-risk entity;
produce a precedent risk-mitigation schedule for the precedent entity profile;
identify a further at-risk entity from the customer segment; and
apply the precedent risk-mitigation schedule to the further at-risk entity.

24. The computer program of claim 23, wherein the at least one code segment is configured to instruct the computer to identify a further at-risk entity from the customer segment by identifying a further at-risk entity having each common parameter, the further at-risk entity being outside the first plurality of at-risk entities.

25. The computer program of claim 23, wherein the at least one code segment is configured to instruct the computer to determine a customer segment by determining a demographic comprising each at-risk entity in the second plurality of at-risk entities.

26. The computer program of claim 23, wherein the at least one code segment is configured to instruct the computer to obtain financial data by receiving payment scheme data from a payment scheme.

27. The computer program according to claim 26, wherein the at least one code segment is configured to instruct the computer to receive financial data by receiving data regarding products or services procured by the first plurality of at-risk entities.
